(19) United States
(12) Patent Application Publication
(10) Pub. No.: US 2013/0008186 A1
(43) Pub. Date: Jan. 10, 2013

(54) CRYOGEN HEAT PLATE HEAT EXCHANGER

(76) Inventor: Michael D. Newman, Hillsborough, NJ (US)

(21) Appl. No.: 13/177,605

(22) Filed: Jul. 7, 2011

(51) Int. Cl. F17C 7/04; F17C 13/02; F17C 3/00

(52) U.S. Cl. 62/48.1; 62/45.1; 62/49.1

(57) ABSTRACT

A heat exchanger includes a first housing disposed in a first atmosphere and having an upstream end, a downstream end and an internal space for a cryogenic substance; and a heat plate assembly mounted to the first housing and being exposed to the first atmosphere for providing heat transfer at an interface of the first atmosphere and the heat plate assembly.

### BACKGROUND

The present embodiments relate to heat transfer for refrigerating spaces such as for example spaces that are in transit.

In transit refrigeration (ITR) systems are known and may include cryogenic ITR systems which use known fin tube heat exchangers for liquid nitrogen and carbon dioxide chilled or frozen applications, or a snow bunker for solid CO₂ snow (dry ice) chilled or frozen applications. Such known systems experience problems of safety, temperature control, cool down rates, dual temperature zone control, efficiency and fouling.

### BRIEF DESCRIPTION OF THE DRAWINGS

For a more complete understanding of the present inventive embodiments, reference may be had to the following drawing figures taken in conjunction with the description of the embodiments, of which:

FIG. 1 shows a side plan view in cross section of a cryogen heat plate heat exchanger embodiment according to the present invention; and

FIG. 2 shows an isometric perspective, partially transparent view of the embodiment in FIG. 1.

### DETAILED DESCRIPTION OF THE INVENTION

Heat plates (flat heat pipes) can be used instead of known fin tube heat exchangers to achieve comparable heat transfer with minimal air surface contact area, thereby eliminating issues resulting from snow accumulation on heat exchanger fins. In addition, the thermal conductivity of heat plates can be adjusted to deliver precise heat transfer rates to the system by using variable conductivity heat plates.

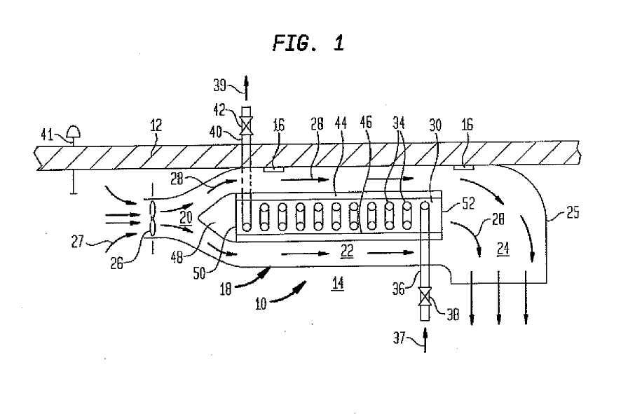

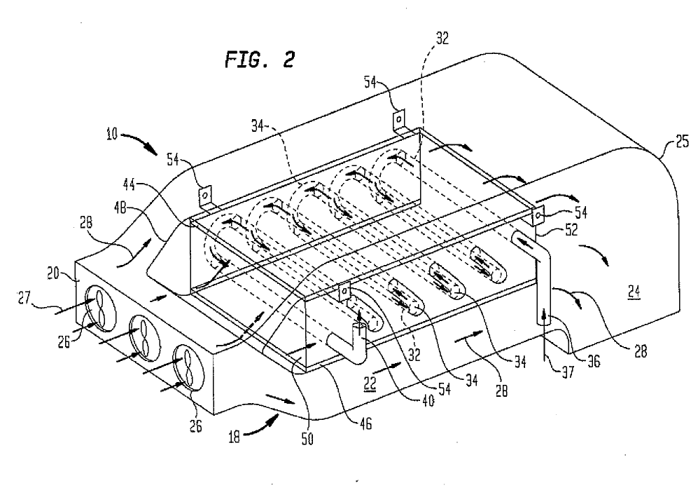

Referring to FIGS. 1-2, a cryogen heat plate heat exchanger is shown generally at 10. The heat exchanger 10 is mounted for use in a compartment having a side wall 12 defining a space 14 in the compartment. The heat exchanger embodiment 10 can be mounted to the side wall 12 by mechanical fasteners 16, such as for example brackets. The side wall 12 may be insulated or vacuum jacketed.

The heat exchanger 10 includes a housing 18 which functions as a shroud. The housing 18 may be referred to herein as a housing 18, shroud or shroud housing. The shroud housing 18 includes an inlet 20 in communication with an internal chamber 22 of the housing, which in turn is in communication with an outlet 24 or discharge end of the housing. A fan 26 or plurality of fans are mounted at the inlet 20 for drawing air 27 from the space 14 into the inlet 20 and moving the air through the internal chamber 22 for discharge at the outlet 24 into the space 14, as indicated by arrows 28 showing an air flow through the housing 18. The outlet 24 may have a curved or arcuate portion 25 to direct the airflow 28 to a more centralized region of the space 14.

Another housing which may be constructed as a solid conductive metal block 30 is disposed in the internal chamber 22 and exposed to the airflow 28. The metallic block 30 can have a rectangular cross section as shown in FIGS. 1-2, or be formed with a cross section of any other shape. Copper is one type of material which may be used for forming the metallic block 30, by way of example only, as other metals or alloys may be used, provided they have sufficient heat transfer capability. An internal area of the block 30 is formed with a plurality of bores or passages 32 as shown in particular in FIG. 2. The plurality of passages form a continuous internal flow path in a serpentine pattern within the block 30. Tubes 34 interconnect adjacent ones of the plurality of passages 32, thereby providing for the continuous internal flow path. It is possible from the construction of the metallic block 30 that the tubes 34 are readily observable if for example the shroud housing 18 is made from transparent material or if said metallic block 30 is removed from said chamber 22 of the shroud housing, thereby providing an indication of the plurality of passages 32 within the block 30.

Liquid cryogen, such as liquid nitrogen (N₂) or liquid carbon dioxide (CO₂), is provided as indicated by arrow 37 through a cryogen inlet pipe 36 in communication with one of the passages 32 in the block 30. A modulating type value 38 may also be installed for use with the inlet pipe 36. The liquid cryogen enters one end of the block 30 and is transferred through the internal flow path to an opposite or terminating end of the flow path where it is discharged as a cryogenic gas or vapor 39 through the cryogen vapor outlet pipe 40. The cryogen vapor outlet pipe 40 may include a modulating type valve 42 which is used to control the mass flow rate of cryogen flowing through the block 30.

A heat plate assembly includes a heat plate 44 fabricated from for example copper or stainless steel and is disposed at one side, such as for example a top or an upper side, of the metallic block 30. The heat plate 44 is exposed to the airflow 28 in the internal chamber 22. A heat plate 46 fabricated from for example copper or stainless steel is mounted to another side, such as for example a bottom or opposed side, of the metallic block 30 and is exposed as well to the airflow 28 within the internal chamber 22.

An airflow separator 48 or airfoil is disposed at an upstream end 50 of the metallic block 30 proximate the inlet 20. The air foil is disposed such that it is positioned at the leading edge or the upstream end 50 of the metallic block 30 to separate the airflow 28 at the inlet 20, such that approximately fifty percent (50%) of the airflow moves along and contacts the heat plate 44, while approximately the other fifty percent (50%) of the airflow 28 moves along and contacts the heat plate 46 at the bottom of the metallic plate 30. Heat flux or heat transfer occurs at an interface at the heat plates 44,46 and the airflow 28.

The airflow separator 48 may have a triangular shape cross-section for example, to bifurcate the airflow 28 to move along upper and lower sides of the metallic block 30, or alternatively have a frustoconical shape to guide the airflow 28 along all sides of the block 30. In most constructions of the heat exchanger apparatus 10, the internal chamber 22 is sized and shaped so that the metallic block 30 takes up or uses most of the volume of said chamber, except where the heat plates 44,46 are located so that the air flow 28 is substantially directed along sides of the metallic block where the heat plates are exposed for contact with said air flow.

The heat from the warm air drawn in by the fans 26 is transferred via the heat plates 44,46 to the colder solid metallic block 30 in which is contained a flow of liquid cryogen 37. The thermal conductivity of the heat plates 44,46 can be adjusted by selecting different sizes of heat plates or different materials from which the heat plates are fabricated, and/or adjusting the fan speed to match the required refrigeration load of the heat exchanger embodiment 10. In addition, variable conductivity heat plates can be used for the plates 44,46 for active control of the heat flux or heat transfer to provide a wide range of heat flux and temperature gradients at the plates and to the airflow 28. Warmer cryogen vapor or gas is discharged from the cryogen vapor outlet pipe 40 for subsequent use or exhaust to the external atmosphere.

The airflow 27 introduced at the inlet 20 is substantially cooled upon exposure to the heat plates 44,46 for discharge at the outlet 24 downstream 52 of the metallic block 30. The airflow 28 cools at the interface of said airflow and the heat plates 44,46. A sensor 41 senses temperature of the space at least upstream of the shroud housing 18.

The metallic block 30 can be mounted in the internal chamber 22 by use of mechanical fasteners 54 or brackets connecting the metallic block to the housing 18.

The cryogen heat plate heat exchanger 10 can be used for example in the compartments of trucks, barges and train flatbeds.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A heat exchanger, comprising a first housing disposed in a first atmosphere and having an upstream end, a downstream end and an internal space for a cryogenic substance; and a heat plate assembly mounted to the first housing and being exposed to the first atmosphere for providing heat transfer at an interface of the first atmosphere and the heat plate assembly.

2. The heat exchanger of claim 1, wherein the internal space comprises a continuous passageway.

3. The heat exchanger of claim 1, wherein the heat plate assembly comprises a plurality of heat plates each of which is mounted in different positions on the first housing.

4. The heat exchanger of claim 1, further comprising an air separator mounted to the upstream end of the first housing and exposed to the first atmosphere for guiding the first atmosphere to flow over and contact the heat plate assembly.

5. The heat exchanger of claim 4, wherein the air separator comprises a triangular cross-section.

6. The heat exchanger of claim 1, further comprising an inlet port in communication with the internal space for providing the cryogenic substance to the internal space, and an outlet port in communication with the internal space for exhausting cryogenic vapor from the internal space.

7. The heat exchanger of claim 6, further comprising an outlet pipe in communication with the outlet port for the cryogenic vapor, and an outlet valve connected to the outlet pipe for controlling exhausting the cryogenic vapor and input of the cryogenic substance to the internal space.

8. The heat exchanger of claim 1, further comprising at least one fan associated with the upstream end of the first housing for moving the first atmosphere over the heat plate assembly.

9. The heat exchanger of claim 2, wherein the continuous passageway is arranged in a serpentine pattern within the first housing.

10. The heat exchanger of claim 1, further comprising a sensor mounted for sensing a temperature of the first atmosphere upstream of the first housing.

11. The heat exchanger of claim 1, wherein the cryogenic substance comprises a cryogenic liquid.

12. The heat exchanger of claim 11, wherein the cryogenic liquid is selected from liquid nitrogen and liquid carbon dioxide.

13. The heat exchanger of claim 1, further comprising a shroud housing having a chamber therein sized and shaped to receive the first housing, a shroud inlet disposed proximate the upstream end of the first housing and in communication with the chamber, and a shroud outlet disposed proximate the downstream end of the first housing and in communication with the chamber, the first housing disposed in the chamber of the shroud housing for the first atmosphere to be directed to contact the heat plate assembly.

14. The heat exchanger of claim 4, further comprising a shroud housing having a chamber therein sized and shaped to receive the first housing and the air separator, a shroud inlet disposed proximate the upstream end of the first housing and in communication with the chamber, and a shroud outlet disposed proximate the downstream end of the first housing and in communication with the chamber, the first housing disposed in the chamber of the shroud housing for the first atmosphere to be directed by the air separator to contact the heat plate assembly.

15. The heat exchanger of claim 1, wherein the first housing is constructed as a metallic block in which the internal space is disposed.

16. The heat exchanger of claim 15, wherein the metallic block comprises metal selected from the group consisting of stainless steel and copper.

17. The heat exchanger of claim 13, further comprising at least one mechanical fastener for fastening the first housing to the shroud housing.

18. The heat exchanger of claim 14, further comprising at least one mechanical fastener for fastening the first housing to the shroud housing.
